(19) United States
(12) Patent Application Publication
(10) Pub. No.: US 2024/0354746 A1
(43) Pub. Date: Oct. 24, 2024

(54) COIN DEPOSIT MANAGING UNIT, AND METHOD IN A COIN DEPOSIT MANAGING UNIT

(71) Applicant: GIESECKE+DEVRIENT ADVANCE52 GMBH, Munchen (DE)

(72) Inventors: Klaus ALFERT, St. Augustin (DE); Lars HUPEL, Munchen (DE); Teresa RIEDL, Gmund am Tegernsee (DE)

(21) Appl. No.: 18/294,244

(22) PCT Filed: Jul. 18, 2022
(86) PCT No.: PCT/EP2022/025332

§ 371 Date: Feb. 1, 2024

(30) Foreign Application Priority Data
Aug. 4, 2021 (DE) 10 2021 004 022.8

(51) Int. Cl. G06Q 20/36; G06Q 20/40

(52) U.S. Cl. CPC G06Q 20/3678; G06Q 20/401

(57) ABSTRACT

A coin deposit managing unit includes a secure execution unit for managing digital coin data sets of a central bank. The secure execution unit is adapted so as to exchange digital coin data sets with coin managing units and transmit registration requests to a coin register of the central bank. A first coin deposit, which comprises at least one first digital coin data set, and a second coin deposit, which comprises at least one second digital coin data set. The coin deposit managing unit manages coin deposits of different users. The first coin deposit comprises a first functional specification which checks the secure execution unit when managing coin data sets, and the second coin deposit comprises a second different functional specification which checks the secure execution unit when managing coin data sets.

### FIELD OF THE DISCLOSURE

The invention relates to a coin deposit managing unit with several coin deposits of different users, a method for creating new coin deposits in a coin deposit managing unit with several coin deposits, and a method for managing coin data sets in a coin deposit managing unit with several coin deposits.

### BACKGROUND

Different approaches to a technical solution are already known for a digital currency issued by a central bank (CBDC).

According to a first approach, coin data sets are secured only cryptographically by a central bank entity, and the cryptographically secured coin data sets are exchanged directly between coin managing units of the users in encrypted form. The coin managing units can check the authenticity of the coin data set on the basis of its cryptographic security, such as signature, and should check in advance a certificate of the central bank and/or of the other coin managing unit for validity within the certificate hierarchy.

According to a second approach, the digital money or the coin data sets are stored in a central or decentralized blockchain of a central bank. However, if a coin data set in a blockchain changes owners within the context of a transaction, a great deal of information (sender/recipient/amount) is often published, and, generally, the sender and the recipient require access to the blockchain at the time of the transaction. Since the blockchain or its server can access the electronic coin data sets, the server can independently execute a transaction—for example, at a predefined point in time.

According to a third approach, the coin data sets are stored by the user, e.g., in a local coin managing unit, and are exchanged directly. A coin register stores a registration for all valid coin data sets so that the user can check the validity of the coin data sets with the aid of the coin register. Since the coin register only comprises registration data sets, it does not have access to the coin data sets themselves.

WO 2020/212331 A1 uses and expands this third approach by which the coin data sets can be exchanged directly between the users. In WO 2020/21331 A1, a directly exchanged coin data set can also be passed on to a further recipient without a connection to the coin register being necessary. The recipient or the further recipient can later generate a new coin data set in the same amount and transmit a request to the coin register that the registration of the old coin data set in the coin register be replaced by a registration of the new coin data set in the same amount.

Furthermore, WO 2020/212331 A1 describes that a local coin managing unit of the user—in addition to the usual management of coin data sets including direct exchange of coin data sets and sending of registration requests-can store coin data sets in a safe module of the user.

### SUMMARY

It is the object of the present invention to create a method, a coin managing unit, and a system in which a payment transaction is designed to be secure, but nevertheless simple.

A coin deposit managing unit comprises a secure execution unit for managing digital coin data sets of a central bank and coin deposits.

The secure execution unit is adapted to exchange digital coin data sets with coin managing units and to transmit registration requests to a coin register of the central bank.

The coin deposit managing unit contains a first coin deposit which comprises at least one first digital coin data set, and a second coin deposit which comprises at least one second digital coin data set.

In the present case, the coin deposit managing unit manages coin deposits of different users. Furthermore, the first coin deposit comprises a first functional specification which checks the secure execution unit in the managing of coin data sets, and the second coin deposit comprises a second, different functional specification which checks the secure execution unit in the managing of coin data sets.

The coin deposit managing unit thus provides coin deposits not only to different users, but with different functional specifications.

The functional specifications are preferably specifications for existing functions of the secure execution unit. As presented in more detail below, in the present case, preferably one of the existing functions of the secure execution unit is restricted, and in particular restricted independently of the amount, by the functional specification. The functional specifications preferably pertain to one (of several) function(s) executable by the secure execution unit. The executable function is completely or partially restricted by the functional specification for the coin deposit. Amount specifications are not functional specifications in the present sense.

Each coin deposit in the coin deposit managing unit forms a coin managing unit together with the secure execution unit. The coin deposit managing unit thus comprises coin managing units of different users. In contrast, conventional coin managing units of a user with his own execution unit manage only coin data sets in one (or more) coin deposit(s) of the user.

The first and/or second functional specification can be a direction specification, and in particular a transmit specification or a receive specification. The sending of coin data sets or the receiving of coin data sets is limited for the coin deposit. In the direction specification, there is preferably a limitation to (no or) one (or more) recipient or sender. A transmit specification can therefore also be referred to as a receive specification. A receive specification can also be referred to analogously as a transmit specification. A receive specification as a direction specification can in particular comprise: no recipients, exactly one recipient; exactly one recipient group; several recipients and/or recipient groups. A transmit specification as a direction specification can in particular comprise: no senders, exactly one sender; exactly one sender group; several senders and/or sender groups. Senders and/or recipients can be indicated by their coin managing unit identifier—for short: sender ID or recipient ID. Sender and/or recipient groups can be indicated, for example, by a portion of a coin managing unit identifier. In particular, each recipient or sender belongs to the group if its coin managing unit identifier comprises the portion, i.e., begins, for example, with this portion or differs only by an individual portion of the identifier. The coin deposits, and in particular the first and the second coin deposits, can comprise a transmit specification and/or a receive specification.

Functional specifications can be provided for the test as a positive or negative test criterion. The function (and thus a transaction) is executed when a positive test criterion is met, or is not executed when a negative test criterion is met. Positive test criteria are preferably used for partially restricting functional specifications. Thus, a partially restricting direction specification preferably contains the permissible senders and/or recipients (positive test criterion). Alternatively or additionally, it is conceivable to store non-permissible senders and/or recipients in the direction specification (negative test criterion). A complete restriction, such as, for example, “no transmitting” or “no receiving” in a direction specification, can also be stored differently in a functional specification. The complete restriction is preferably stored as content of the functional specification (such as “not permissible” or “no”). Alternatively, storing an empty content (“or”) or an invalid content (such as “-” as a number, ID, or . . . ) could indicate the complete restriction. It can be provided to store one (or more), non-restricting, functional specification(s). An example would be a coin deposit that may transmit to any recipients, but may only receive from certain senders. In preferred embodiments, the non-restricting functional specification is indicated by the absence of this specification; in the example: for the coin deposit, there is a sender specification, but no recipient specification. Alternatively, however, the content of the functional specification can indicate that the functional specification does not contain any restriction, in example: recipient specification with content “any,” “all,” “*,” or the like.

In preferred embodiments, a transmit specification (or receive specification) of a coin deposit, i.e., in particular, also of the first and/or second coin deposit, differs from its receive specification (or transmit specification). The direction specifications are therefore preferably designed asymmetrically for a coin deposit.

In alternative or supplementary embodiments, at least one partially restricting transmit specification limits the sending of coin data sets to exactly one recipient, exactly one recipient group, or multiple recipients and/or recipient groups. The recipient(s) and/or recipient group(s) are contained in the specification, and in particular by indication of a recipient ID, a recipient group ID or a portion of a recipient ID, or a certificate group. A certificate can have a coin managing unit as a member of a group, e.g., as a group certificate, such as “ID/key belonging to group XY,” or as an attribute certificate, such as “attribute YZ met.” In the specification, a recipient group can also be indicated, for example, by the group and/or a certificate type, such as “certificate for group XY” or “certificate for attribute YZ.” For example, the specification can request a certificate for the attribute, “BookStores,” from the publisher group, “SchöneBücher.” In alternative or supplementary embodiments, at least one partially restricting receive specification limits the receiving of coin data sets to exactly one sender, exactly one sender group, or multiple senders and/or sender groups. The sender and/or sender group(s) are contained in the specification, and in particular by indication of a sender ID, a sender group ID or a portion of a sender ID, or a certificate group. In the specification, a recipient group can also be indicated, for example, by the group and/or a certificate type, such as “certificate for group XY” or “certificate for attribute YZ.”

In alternative or supplementary embodiments, the first functional specification comprises the second coin deposit as transmit specification or as receive specification of the first coin deposit. Particularly preferably, the second coin deposit can thus be an authorized or the only authorized recipient or transmitter for coin data sets of the first coin deposit.

In the context of a transaction, at least one coin data set is exchanged between two coin managing units, including the first or second coin deposit. Preferably, for a coin data set derived from the exchanged coin data set, a registration request is sent to the coin register, and/or a transaction data set is sent to a transaction register. The at least one coin data set is initially stored at the sender, such as the first or second coin deposit, of the coin data set. The coin data set (or a coin data set derived therefrom) is stored at the recipient after the transaction. Preferably, the coin data set is transmitted directly between the sender and recipient; in particular, the coin data set can be forwarded directly to another recipient. WO 2020/212331 A1 already describes the corresponding basic principle. However, the present solution is not bound to the masking of the amount of the coin data sets described there or to the specific protocols in WO 2020/212331 A1.

The first and/or the second functional specification can be a specification for conditional transactions.

The secure execution unit of the coin deposit managing unit can be configured to carry out conditional transactions only at a later point in time, when a condition is met. The conditional transaction is preferably temporarily stored in the coin deposit managing unit. The conditional transaction can be (temporarily) stored in a (buffer) memory of the coin deposit or in a (buffer) memory, extending over more than one coin deposit, of the coin deposit managing unit. For the (buffered) conditional transaction, which contains a condition (and preferably the data of the transaction to be executed), the secure execution unit checks whether the condition is fulfilled and only then executes the transaction. A conditional transaction may include a time condition, which preferably specifies a time as of which the conditional transaction is to be executed. The secure execution unit recognizes that the temporal condition has been met, i.e., in particular, the point in time has been reached, and executes the transaction. The temporal condition can indicate, alternatively or as an additional point in time, as of when the conditional transaction is no longer to be executed (executable “until” or “from until”). Such a temporal condition is generally linked to an additional condition. A conditional transaction can comprise an external condition (triggering event) and/or a security value. The temporarily stored conditional transaction is only executed when the security value has been received and/or a confirmation for the presence of the external condition/for the external event has been received. In particular, the recipient of the transaction or a third party can for example trigger the transaction if he knows the security value and transmits it as a trigger (possibly together with the ID of the coin managing unit and/or a transaction number). For example, a random value or a cryptographic security value (hash value of data/signature of data/ . . . ) can serve as a security value.

Conditional transactions are preferably executed exactly once. However, it is possible to provide conditional transactions which are executed several times—in particular, even with or without a restriction on the number of executions (e.g., every 2 weeks or, conditional upon the event, exactly four times). The stored conditional transaction can be executed, i.e., for example, with the stored amount and recipient, or, alternatively, a requested transaction—in particular, requested by a third party/recipient—can be executed, which falls under the stored conditional transaction. Thus, for example, a transaction requested by the recipient with a transaction amount that is smaller than the stored amount and/or a recipient who belongs to a stored recipient group.

A functional specification for conditional transactions can in turn contain a full, partial, or no restriction. Thus, the first functional specification can indicate that conditional transactions are not permitted for the first coin deposit (full restriction), and the second functional specification can indicate that conditional transactions are possible for the second coin deposit, either without restriction or with partial restriction. Alternatively, the first functional specification for the first coin deposit could contain a partial restriction for conditional transactions, and the second functional specification for the second coin deposit could contain no restriction for conditional transactions. Alternatively, the two functional specifications for the coin deposits could restrict conditional transactions differently. The functional specification for conditional transactions can relate to or contain a type of condition (e.g., temporal, with trigger and/or with securing value) and/or a type of transaction (e.g., a simple transaction or a complex transaction, such as: with counter-performance or with several recipients or with recipient and sender) and/or a directional specification (as sender and/or as recipient). There can be various types of conditional transactions, which differ in terms of their complexity and/or their coding (conditional transaction encoded according to standard A or type B or proprietary C . . . ). The various types of conditional transactions are supported by the secure execution unit, but in the present case are still permitted only selectively or in a restricted manner for coin deposits.

The first and second functional specification preferably relate to the same function that can be executed by the secure execution unit. The two coin deposits are restricted differently by the different functional specifications for a function. The first and the second coin deposit can each comprise several functional specifications. A coin deposit can, for example, comprise several direction specifications and/or several specifications for conditional transaction and/or other functional specifications.

In addition to the functional specifications, there can be amount specifications. The first and/or the second coin deposit can comprise a value specification, i.e., a non-functional specification. An amount specification can be a maximum value of the amount of the coin data sets to be sent and/or for the amount of the coin data sets to be received. A corresponding amount specification can also be provided for conditional transactions. Further alternatively or additionally, an amount specification can specify a maximum value or a minimum value for the total amount of the coin data sets stored in the coin deposit.

The first and the second coin deposit can be assigned to a first (the same) user. The first user has two coin deposits in the coin deposit managing unit, which comprise different specifications. Alternatively, the first coin deposit can be assigned to a first user, and the second coin deposit can be assigned to a second user. The first and/or the second user can have several coin deposits in the coin deposit managing unit and one (or more) local coin managing unit(s), e.g., in the form of a security module, such as a chip card, SIM card, RFID token, NFC module, installed security module. The coin deposit managing unit is provided by an operator, which can, for example, be a financial service provider, such as a business bank, a credit card provider, or a payment service provider (PayPal, etc.). The creation of the coin deposit is usually commissioned by a third party-the issuer.

The first and second functional specification can preferably comprise: (in each case) a defined functional minimum specification, which is initially defined in particular by an issuer of the coin deposit. Alternatively or advantageously, the first and the second functional specification (in each case) comprise a selectable functional specification, which is to be selected in particular by the user such that it is narrower than a defined functional minimum specification of the issuer. The user therefore has the option of further restricting a specification of the publisher. The specifications can be referred to as issuer specifications and user specifications. Of course, specifications that are valid system-wide are (permanently programmed in the secure execution unit and) no longer definable by the issuer or selectable by the user. The issuer can accordingly also define its specifications only to be narrower than the system specifications. The secure execution unit thus complies with system specifications and also checks the (functional and other) specifications of the coin deposit.

The first and/or the second coin deposit further preferably comprises one or more of the following data elements: a unique coin managing unit identifier, which in particular identifies the coin deposit and the secure execution unit together; a public coin managing unit key of an asymmetric key pair; optionally, a secret coin managing unit key of the asymmetrical key pair; and/or a coin managing unit certificate, which in particular comprises the coin deposit identifier and/or the public coin deposit key as certified content.

One of the following is preferably used as the coin managing unit identifier:
a Uniform Resource Identifier (URI)—in particular, according to RFC 3986,
a Uniform Resource Name (URN)—in particular, according to RFC 8141, and/or
a Universally Unique Identifier (UUID), unique system-wide—in particular, according to RFC 4122. The URI can contain a UUID and/or a URN.

As portions, the URI comprises, for example, a scheme, such as a URN or UUID, a provider, such as an operator name or domain name of the operator, and the unique portion, such as a UUID or serial number. In one example: urn: uuid: 965ecc78-3182-4d5b-8f6a-le325b336031.

As components, the URN comprises for example a resource type (example:

coin managing unit), an operator name—usually the domain name of the operator (example: myBank.com)—and a portion (examples: serial number or UUID) that is unique at least for the operator, but preferably system-wide. A sender and a recipient of a transaction could then be indicated, for example, as follows: sender ID: coinmanagingunit: my-bank.com: dlafujr3jbd” or recipient ID: coinmanagingunit: your-bank.com: 3hbbda903988r.”

In a UUID “xxxxxxxx-xxxx-Mxxx-Nxxx-SVxxxxxxxxxx” according to RFC 4122, the version is encoded in the half-byte M, and the variant of the UUID is encoded in the half-byte N. A functional specification can now be indicated in at least one additional portion of the UUID, such as the half-bytes S and/or V (in version 4, variant 1). For example, it can thus be encoded in the half-byte S that the coin deposit is present in a coin deposit managing unit. At least short functional specifications can be encoded in a portion of the UUID such as this or an additional half-byte. For example, “no direction restriction,” “no transmitting,” or “no receiving” could be encoded in 3 bits. Likewise, a specification for conditional transactions could be encoded in the 3 bits or additional 3 bits-for example, the permissibility of three types of conditions or of three types of conditional transactions could be encoded.

The coin managing unit identifier can comprise at least one (short) functional specification or a portion of the functional specifications. A certificate can contain more data than an identifier. Accordingly, the coin managing unit certificate can contain one or more functional specifications.

The first and/or the second coin deposit can comprise a partially freely-readable specification, and in particular also the first or second functional specifications. In particular, a readable portion and a non-readable portion of the at least partially freely-readable specification can be present. The two portions are preferably stored in different data elements—in particular, a freely-readable data element, such as the coin managing unit certificate or identifier or a non-confidential specification data element, and in a non-freely-readable data element of the coin deposit, such as a dedicated confidential specification data element. Alternatively, the two portions are stored in a common data element in a non-freely-readable manner, and the readable portion is additionally stored in a separate readable data element, such as the coin managing unit certificate or identifier, or a non-confidential specification data element.

In preferred embodiments, the coin deposit managing unit provides an interface for the retrieval of specifications (and/or conditions) of the coin deposits for other coin managing units. The other coin managing unit transmits the ID of a coin deposit of the coin deposit managing unit to the interface. In response to a retrieval for a coin managing unit ID, the associated, readable specifications and/or conditions of the coin deposit are transmitted in particular separately from a certificate (for the public key) of the coin deposit or in addition to a certificate (for the public key) of the coin deposit.

The coin deposit managing unit stores the coin deposits preferably in encrypted form. The coin deposit data set (of the coin deposit) is only decrypted in order for the coin deposit data to be read. Particularly preferably, the coin data sets are individually encrypted, and further preferably encrypted with individual keys. The coin deposit managing unit can advantageously comprise a high-security module, which stores at least one key. The high-security module provides the (or the individual, and, optionally, individually derived) decryption keys. The high-security module can also store additional keys, such as the at least one secret key of the (or each) coin deposit, which can serve, for example, for signature generation, authentication, or decryption. The secure execution unit then requires, for example, a signature, an authentication value, or a decryption from the high-security module so that the secret keys are only used in the high-security module. As an alternative to the use of a high-security module, the management of the keys can also be divided among several computers in the coin deposit managing unit; only the several computers together can calculate and/or use the key required in each case.

The first and/or the second functional specification can alternatively be a counter-performance specification. The counter-performance is preferably provided in response to at least one received coin data set, and in particular in the response data to the sender of the received coin data set.

The secure execution unit can transmit transaction register data to a transaction register for managing the coin data sets. The transaction register data comprise in particular a unique transaction identifier, a transaction amount, a coin managing unit identifier of the sender, a coin managing unit identifier of the recipient, and the (at least one) register reference of the coin data set in the coin register.

Alternatively or additionally, the secure execution unit can transmit registration requests to the coin register for managing the coin data sets, which in particular comprises at least one register reference of a coin data set previously registered in the coin register and a register reference of a coin data set to be registered in the coin register.

Alternatively or additionally, the secure execution unit can receive a transaction request for managing the coin data sets (from a user or another coin managing unit) and/or transmit or receive a coin data set (or execute transactions with other coin managing units). The transaction request comprises in particular a transaction amount, a coin managing unit identifier of the sender, and a coin managing unit identifier of the recipient. In the case of a conditional transaction, the transaction amount of the transaction to be executed could already be present, or could be a transaction upper limit. Likewise, for conditional transactions, the transaction partner (preferably the recipient) can be specified with his ID or as a group. Accordingly, either the temporarily stored conditional transaction or a separately requested transaction, which falls under the stored conditional transaction, is executed. Only optionally does the transaction request further comprise a unique transaction identifier and/or a transaction reference text. Executing a transaction with another coin managing unit comprises the transfer of at least one coin data set from the coin deposit to the other coin managing unit (recipient).

A method for managing coin deposits in a coin deposit managing unit that comprises a secure execution unit for managing digital coin data sets of a central bank, a unit for creating new coin deposits, and several coin deposits of different users comprises the following steps:
receiving a request to create a new coin deposit; and
creating the new coin deposit by storing coin deposit data.
   In the present case, the request comprises a functional specification. The functional specification of the request is stored in the coin deposit data.

The unit for creating new coin deposits preferably carries out at least one, several, or all of the following steps:
checking an authentication contained in the request;
generating a coin managing unit identifier, which in particular comprises a portion of a specification, and preferably of the functional specification;
generating a coin managing unit key;
providing a coin managing unit certificate, which in particular comprises a portion of a specification or an additional portion of the specification, and preferably of the functional specification. The certificate preferably comprises the ID and/or a public key of the coin managing unit. The provision can comprise creating the certificate in the coin deposit managing unit. Alternatively, the certificate is received (externally created) from the coin deposit managing unit.

An authentication for the request is preferably checked by checking an authentication that is contained in the request. Alternatively, the authentication of the requester can also be checked already before or after receipt of the request. The requester is preferably an issuer of the coin deposit. The requester is thus usually a third party, i.e., neither the user of the coin deposit nor the operator of the coin deposit managing unit.

The steps of generating the identifier, key, and/or certificate preferably take place before the storage of the coin deposit data, so that the stored coin deposit data comprise at least the identifier and optionally also the key, and further optionally the certificate. Alternatively, one or more of the steps of generating can also take place after the step of storing the coin deposit data. The coin deposit is preferably stored without the certificate of the coin managing unit, and further preferably also without the key of the coin managing unit, and alternatively or even more preferably without the identifier.

The request for creating the new coin deposit can comprise a user (name) for which the new coin deposit is created. The user (name) is not usually stored in the coin deposit data. An assignment of the coin deposit to the user is preferably stored in a separate storage unit by the operator of the coin deposit managing unit. In particular if the user is already known, the identifier, key, and certificate of the coin managing unit are already generated during the creation of the coin deposit and stored in the coin deposit, i.e., not generated and stored only afterwards.

The new coin deposit can also be created without a user assignment. An assignment of the created new coin deposit to a user then takes place in response to an assignment request. The assignment request requests the assignment of a coin deposit to the user, which in turn is preferably stored in the separate memory unit of the operator. The assignment request can be received by the issuer, the user, or a third party. The assignment request of the user or third party may comprise an authorization code that the user has received from the issuer.

The stored coin deposit data preferably comprise at least one coin data set. In particular, the secure execution unit for managing digital coin data sets can receive a coin data set for the new coin deposit and/or send a registration request to a coin register of the central bank. For a coin data set, received from the secure execution unit, which is already/previously registered in the coin register, the registration request can request the registration of a coin data set to be stored in the new coin deposit. In the coin register, the new coin data set is then registered (stored as valid), and the previously registered coin data set is no longer registered (deleted or stored as invalid).

A method for managing digital coin data sets of a central bank in a coin deposit managing unit which comprises a secure execution unit and several coin deposits of different users, having the steps of:
receiving a transaction request relating to a coin deposit;
reading the coin deposit data of the coin deposit;
checking a specification, and
depending upon a result of the check, executing or storing (or not executing or storing) a transaction corresponding to the transaction request. In the present case, in the step of checking, a functional specification contained in the coin deposit data is checked.

The functional specification can be a direction specification. The execution of the transaction comprises sending and/or receiving a coin data set. Alternatively or additionally, the functional specification can be a specification for conditional transactions. The conditional transaction is carried out only later, when a condition is met. The functional specification can further, alternatively or additionally, be a specification for counter-performances. The execution of the transaction includes providing the counter-performance, wherein in particular the transaction request includes a coin data set. The transaction can be a simple transaction (transmission or reception of coin data set), with or without provision of a counter-performance, or a conditioned transaction, with or without provision of a counter-performance.

The transaction request for storing a conditional transaction can be received by the user, and the conditional transaction is then stored as a conditional transaction released by the user. During storage, the conditional transaction can only be temporarily stored and executed if a triggering condition is met. The transaction is then executed at least with the temporarily stored transaction amount and the temporarily stored transaction partner. Alternatively, when the conditional transaction is stored, it is stored as the user's release frame for subsequent transaction requests from a third party who is already named in the conditional transaction—in particular, as a recipient. The transaction of the transaction request or a separately requested transaction (of a third party—preferably the recipient) is executed if it falls under a stored conditional transaction released by the user. If the current transaction request (with recipient ID and transaction amount) meets the specification and meets under the conditional transaction previously stored by the user (for example, with the recipient ID and a maximum transaction amount), the requested transaction is executed.

A transaction request comprises in particular a transaction amount, a coin managing unit identifier of the sender, and a coin managing unit identifier of the recipient. Only optionally, it also comprises a unique transaction identifier and/or a transaction reference text. The user of the coin deposit generally transmits a transaction request. In embodiments, the transaction request can also be transmitted from another coin managing unit or a transaction partner (sender or recipient of coin data sets) to the coin deposit managing unit. The step of executing the transaction comprises transmitting at least one coin data set from the coin deposit to a recipient (or receiving at least one coin data set, which is contained in particular in the transaction request). In the step of executing the transaction, a coin data set to be transferred can be generated and registered in the coin register, and in particular if the amount of the coin data set to be transferred is to correspond to a transaction amount. At least one coin data set, i.e., optionally, two or more coin data sets, of the coin deposit are transferred in the step of executing the transaction. Coin data sets can be transferred separately or in transaction messages, for example, together with a transaction ID—in particular, if an encrypted connection is already established between the sender and the recipient. Alternatively, however, a complete transaction message can also be transferred (directly between coin deposit managing units). A complete transaction message contains in particular the data elements contained in the transaction request and the at least one coin data set.

Transaction requests, coin data sets, and/or complete transaction messages can preferably be contained in an HTTP message. Transaction requests, coin data sets, and/or complete transaction messages can alternatively or additionally be transferred in a JSON format. The JavaScript Object Notation (JSON) format preferably corresponds to RFC 8259 (and/or ECMA 404 or ISO/IEC 21778). A transaction ID can be formatted as a UUID. A transaction request could then, for example, be formatted as follows:

{
″Sender″: “urn:coinmanagingunit:my-bank.com:dlafujr3jbd,”
“recipient”: “urn:coinmanagingunit:your-bank.com:3hbbda903988r,”
“amount”: “1.60 eCBDC”
“transaction reference text”: ″process number 1234898942″
}
An associated transaction message, here with 2 coin data sets, could then be formatted, for
example, as follows:
{
″Transaction ID″: “1c102b5f-5496-459d-8a67-3bf1c348b113,”
“Sender”: “urn:coinmanagingunit:my-bank.com:dlafujr3jbd,”
“recipient”: “urn:coinmanagingunit:your-bank.com:3hbbd903988r,” “coindatasets”: [
{
″Amount″: 1,000, ″... Number”:“116e782982383e9d0ea2c728f2a5f80d8a6121″
},
{
″Amount″: 60, ″... Number″: “1aaa77777777777733333c9123812123712814″
}
],
“Transaction reference text”: “Invoice 1234898942”
}

The described methods can be carried out in one of the coin deposit managing units described above. The different methods and embodiments can be combined with one another and can relate, for example, to different coin deposits or to the first and/or second coin deposit, respectively.

A digital central bank currency system comprises a coin deposit managing unit—in one of the described embodiments, or set up to execute one of the methods described. The system further comprises the coin register of the central bank and optionally a plurality of coin managing units and/or further coin deposit managing units, and/or a transaction register.

The present solution is particularly advantageous, since the high flexibility in the coin deposit managing unit can be offered independently of the coin register and/or the transaction register. In particular, the coin register, which is already subject to particularly high requirements in a digital currency system, is not slowed down.

### BRIEF DESCRIPTION OF THE DRAWINGS

The invention and further embodiments and advantages of the invention will be explained in more detail below with reference to figures, wherein the figures describe merely exemplary embodiments of the invention. Identical components in the figures are provided with the same reference signs. The figures are not to be considered true to scale; individual elements of the figures may be illustrated excessively large or excessively simplified.

In the figures:

FIG. 1 shows a digital central bank currency system with coin managing units and a coin register of the central bank;

FIG. 2 shows a coin managing unit with an execution unit and a coin data set;

FIG. 3 shows a digital central bank currency system with a coin deposit managing unit;

FIG. 4 shows a coin deposit managing unit;

FIG. 5 shows a flowchart for a method with a transaction request;

FIG. 6 shows a flowchart for a method with a coin deposit request;

FIG. 7 shows a flowchart for a method with a request for a conditional transaction;

FIG. 8 shows an exemplary embodiment for specifications of a coin deposit.

### DETAILED DESCRIPTION OF VARIOUS EMBODIMENTS

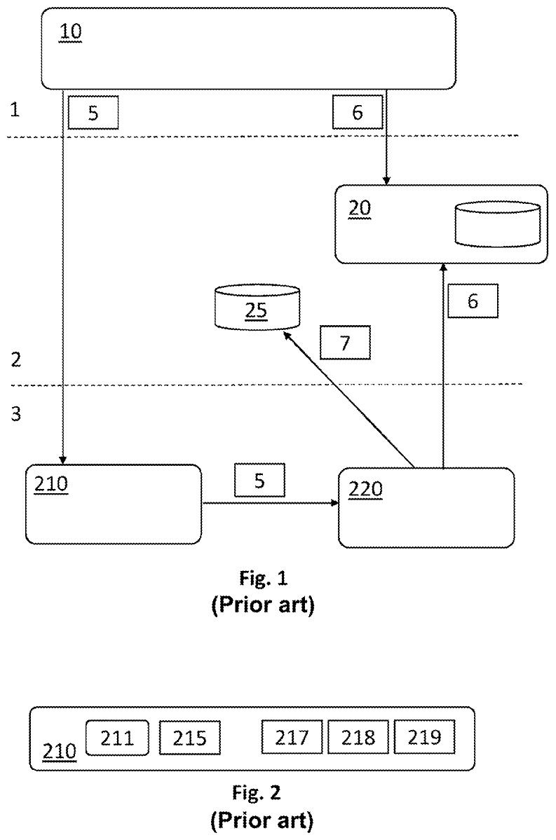

FIG. 1 shows a digital central bank currency system, as is already known per se. The division of the system into an output layer 1, a system management layer 2, and a transaction layer 3 is shown by dashed lines.

A central bank entity 10 issues digital coin data sets 5. The central bank entity 10 also requests an initial registration of the digital coin data set 5 in a coin register 20 of the central bank. Coin managing units 210, 220 can exchange digital coin data sets and transmit registration requests to the coin register 20.

Transaction data sets 7 are stored in an optional transaction register 25. A transaction data set 7 is, for example, the transaction amount, a transaction ID, identifiers for sender and recipient—here, the coin managing unit 210 as the sender and the coin managing unit 220 as the recipient—and at least the register reference of the transferred coin data set 5.

The coin register 20 stores a register data set 6 at least for each valid digital coin data set 5. The register data set 6 contains, for example, the amount of the coin data set and a register reference. The register reference can be derived from the coin data set 5, but does not allow the determination of the coin data set 5. In FIG. 1, the initial registration request transmitted by the central bank entity 10 contains the register data set 6. In the figure, it is shown that the first coin managing unit 210 receives the digital coin data set 5 from the central bank entity 10. However, the digital coin data set 5 can also be issued indirectly by the central bank to a coin managing unit of a user (e.g., via a commercial bank) or have been received from another coin managing unit.

The digital coin data set 5 can be transferred from the first coin managing unit 210 directly to the second coin managing unit 220. The second coin managing unit can check the validity of the coin data set 5 with the aid of the coin register. It can transmit a validity request, which contains the register reference that can be derived from the coin data set 5 and optionally the amount, to the coin register 20. The coin register 20 checks whether the register reference is present and, if applicable, confirms that the coin data set 5 is valid. Alternatively, the coin managing unit 220 generates a new coin data set and transmits a registration request, which comprises at least the register reference of the previously valid coin data set 5 and a register reference of the new coin data set, to the coin register 20. The registration request is checked in the coin register 20. In the simplest case, the register reference of the new coin data set is registered, and the previously valid register reference is deleted (or marked as invalid).

If a coin managing unit 210, 220 generates a new coin data set in the same amount and registers the new coin data set instead of the previous coin data set, this is also referred to as a switchover. However, coin managing units 210, 220 can also divide or connect coin data sets, i.e., generate a new coin data set to be registered from several previously valid coin data sets or generate several coin data sets to be registered from one previous coin data set. The coin register 20 then checks in particular whether the registration request (with the associated several previous or new register references) is neutral in terms of the amount. WO 2020/212331 A1 describes corresponding examples. However, the present solution is not bound to the masking of the amount of the coin data sets described there or to the specific protocols in WO 2020/212331 A1.

The approach shown in FIG. 1 is particularly advantageous, since neither the coin register 20 nor the transaction register 25 have to comprise coin data sets 5.

FIG. 2 shows a coin managing unit 210 with its typical components. The coin managing unit 210 comprises an execution unit 211 and at least one coin data set 215. The execution unit 211 is generally designed as software and is configured to manage the coin data sets of the coin deposit (transmit/receive coin data sets, transmit registration requests).

Furthermore, the coin managing unit 210 comprises an identifier of the coin managing unit 217. In the following, identifiers are also sometimes referred to as ID's for short-for example, as a sender ID or recipient ID. A cryptographic key 218, and optionally an asymmetrical key pair, and a certificate of the coin managing unit 219 are additional data elements of the coin managing unit 210. The cryptographic key preferably serves to authenticate the coin managing unit and/or to sign data—in particular, in the context of a transaction. The certificate can pertain to the identifier and/or the key—generally the public key of a key pair 218—of the coin managing unit.

In FIGS. 1 through 4, data elements, such as the coin data sets 215, are shown with rectangular boxes, and functional units, such as the execution unit 211, are shown with rounded corners.

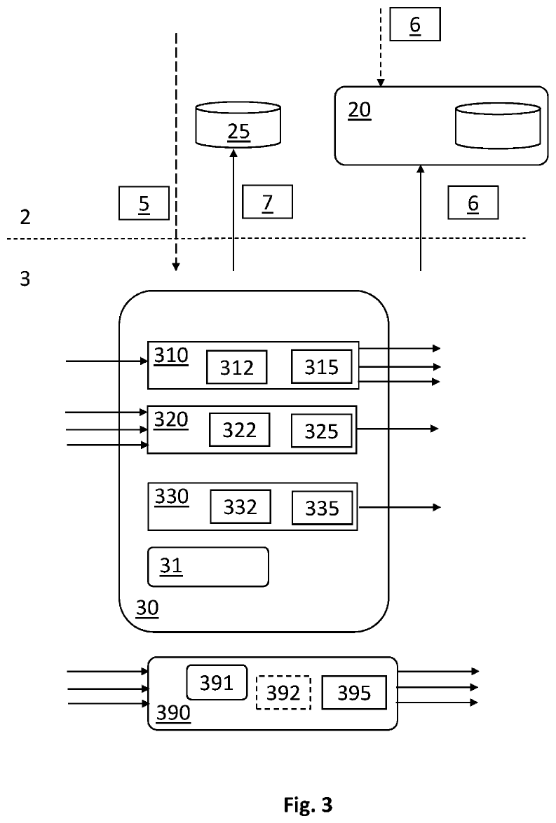

FIG. 3 shows a coin deposit managing unit 30 with several coin deposits 310, 320, and 330 of different users and an execution unit 31 for managing coin data sets. The coin deposits 310, 320, 350 comprise at least one coin data set 315, 325, 335. The coin deposits 310, 320, 330 are coin deposit data sets, i.e., consist of data elements, such as the at least one coin data set in each case and additional data elements. A coin managing unit 390, which comprises an execution unit 391 and coin data sets 395, is also shown. The coin deposits 310, 320, 330 each form independent coin managing units 310.31; 320.31; 330.31 together with the common execution unit 31. Each of the coin managing units 310.31; 320.31; 330.31, 390 will comprise its own ID's, keys, and/or certificates. Both the coin deposit managing unit 30 and the coin managing unit 390 are arranged in the transaction layer 3. For the sake of completeness, the coin register 20 of the central bank with register data sets 6 and the optional transaction register 25 with a transaction data set 7 are also shown in the system management layer 2, in addition to a coin data set 5.

At least one functional specification 312 is contained in the first coin deposit 310, which here is in particular a direction specification. The second and third coin deposits 320, 330 also each contain a functional specification 322, 332. The functional specifications 312, 322, 332 of the coin deposits are different. The secure execution unit 31 checks the functional specification 312, 322, 332 of the corresponding coin deposit 310, 320, 330 before it executes a transaction, i.e., in particular, sends a coin data set of the coin deposit or stores a received coin data set in the coin deposit.

In FIG. 3, the difference in the functional specifications is indicated by (send and receive) arrows at the coin deposits 310, 320, 330, since, in this example, the coin deposits 310, 320, 330 are to have different direction specifications. At the same time, the send and receive arrows in the figure show that the send direction and the receive direction (or the sending or receiving of coin data sets) of the coin deposits are to be restricted differently in this example.

The functional specification 312 of the first coin deposit 310 limits the first coin deposit 310 to receiving coin data sets from specific senders (sender specification). This is indicated in the figure by the single receive arrow coming from the left. One or more permissible senders are contained with their (sender) ID in the functional specification 312. The three send arrows pointing to the right are here intended to indicate that the first coin deposit 310 can send its coin data sets 315 to any recipients. The first coin deposit 310 is thus unrestricted with regard to the recipient and partially restricted with regard to senders.

The functional specification 322 of the second coin deposit 320 limits the second coin deposit 320 to the sending of coin data sets 325 to specific recipients (recipient specification). This is indicated analogously by only one send arrow at the coin deposit 320. One or more permissible recipients are contained with their (recipient) ID in the functional specification 312. As the three reception arrows at the coin deposit 320 indicate, the second coin deposit 320 should, in contrast, be able to receive coin data sets from any senders. The first coin deposit 310 is thus unrestricted with regard to the senders and partially restricted with regard to recipients.

The third coin deposit 330 is restricted in both directions, as can be seen from the single transmission arrow. In this respect, the third coin deposit 320 comprises two functional specifications 332. The third coin deposit 320 is in turn restricted to the sending of coin data sets 335 to specific recipients (recipient specification). In addition, the third coin deposit 320 is not permitted to receive any coin data sets. The third coin deposit 310 is therefore fully restricted in the receiving direction and partially restricted in the sending direction.

The coin managing unit 390 is intended to serve first of all as a counterexample that is unrestricted in both directions, i.e., can transmit to any ID's or can receive from any ID's. As will be briefly described in more detail below, each coin deposit together with its execution unit 31 of the coin deposit managing unit 30 forms a coin managing unit to which a coin managing unit identifier is assigned. The fact that this identifier (ID) is also stored in the coin deposit is not shown in FIG. 3. Recipients or senders of coin data sets can thus be independent coin managing units, such as the coin managing unit 390, coin managing units in the shown coin deposit managing unit 30, or coin managing units in another, further coin deposit managing unit (not shown), in the present sense.

Each of the coin deposits 310, 320, and 330 is assigned to a user. However, the assignment of the coin managing unit ID to the user is preferably not stored in the coin deposit and further preferably not in the coin deposit managing unit 30, but, rather, in an external (not shown) data structure (which contains the ID together with the complete name of the user). The coin deposit managing unit 30 comprises coin deposits of different users; the coin deposits shown can be assigned to different users, or at least some of them to a single user.

In embodiments, the coin deposit 310, 320 also includes a functional specification for the non-existent restriction in the other direction. For example, the coin deposit 310 would comprise one or more transmitter ID's-ID's of coin management units permitted as transmitters—in a receive direction specification and additionally a transmit direction specification in which the non-restriction is encoded (for example, by “*” or “all” for any ID's). The second coin deposit would then analogously contain a receiving direction specification in which the non-restriction is encoded (for example, by “*” or “all” for any ID's).

It should be noted that a functional specification can comprise not only exactly one ID, or several ID's, but can also comprise groups of ID's or mixtures of groups and individual ID's. A group of ID's can be indicated, for example, by an ID mask. The ID mask provides only portions of an ID which must correspond, such as “ABC??1311560*.” For example, all ID's that have a particular initial portion and/or middle portion (in the example, beginning “ABC” and middle “1311560”) can be permissible independently of the specific values in additional portions (in the example, the two characters?? or a serial number following in the final portion).

An additional possible embodiment will now be described with reference to FIG. 3 on the basis of another interpretation of the meaning of the arrows on the coin deposits 310, 320, 330, and 390. One arrow in FIG. 3 could indicate exactly one recipient/sender, and three arrows could indicate a restriction to more than one recipient/sender.

In this embodiment, the two functional specifications 312 of the coin deposit 310 are as follows. Receiving is permitted only from the exactly one sender contained in the functional specification for the receiving direction. Sending is permitted only to the multiple ID's or group of ID's (multiple recipients and/or one or more recipient groups) contained in the functional specification for the sending direction. The coin deposit 320 is thus also partially restricted in both directions. There is only exactly one permissible recipient for the coin deposit 320.

Likewise, there is then only one permissible recipient for the coin deposit 330. The functional specifications according to the two interpretations of the arrows can of course be present in any combination for coin deposits of the coin deposit managing unit 30.

The coin managing unit 390, which is still unrestricted according to the preceding explanation, can now have at least one functional specification 392, and preferably one for each of the two directions. It could thus also be partially restricted in both directions.

An issuer of a coin deposit could, in one example, provide a coin deposit 330 with coin data sets 335 for a user and define the only permissible recipient or a single permissible recipient group in advance.

An issuer of coin deposits could, in another example, create the second coin deposit 320 without a receipt restriction and the first coin deposit 310 without a transmission specification restriction for a user. The second coin deposit 320 is thereby restricted to transmitting to the first coin deposit 310. The first coin deposit 310 can be unrestricted or differently restricted in the receipt direction.

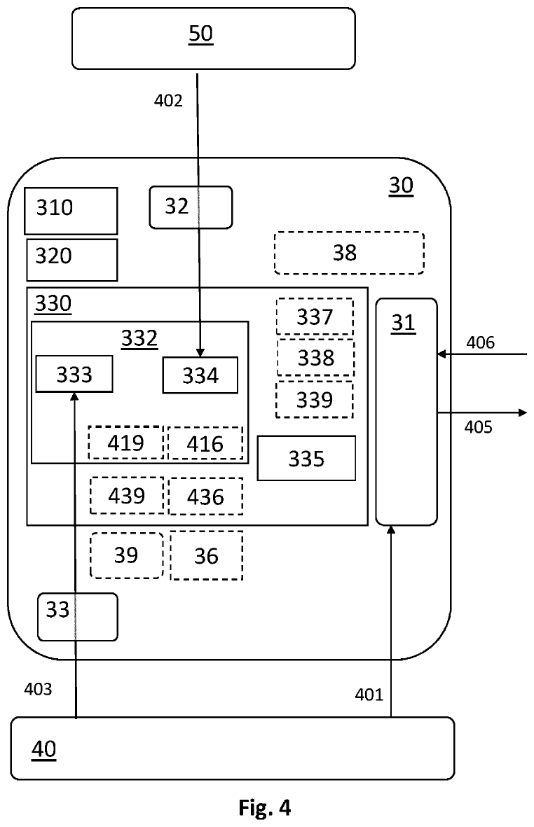

FIG. 4 shows a coin deposit managing unit 30, a user unit 40, and an issuer entity 50.

The coin deposit managing unit 30 in turn comprises the coin deposits 310, 320, 330 and the execution unit 31. The coin deposit data set of the coin deposit 330 is shown in more detail; it contains functional specifications 332 and exactly one coin data set or several coin data sets 335.

Data elements or units that may be optional are shown here and in the additional figures with dashed lines. For example, an identifier 337, at least one key 338, and a certificate 339 (in each case of the coin managing unit, formed by the coin deposit 330 and the execution unit 31 of the coin deposit managing unit 30) are contained in the coin deposit 330 as optional, but generally present, data elements.

The functional specifications 332 comprise issuer specifications 334 and user specifications 333. The issuer specifications 334 are permanently predefined by the issuer of the coin deposit. They can already be contained in a coin deposit request 402. In contrast, the user specifications 333 can be freely selected by the user, at least if they are narrower than a (possibly existing, similar) issuer specification 333. Proceeding from a fully restricting issuer specification, such as “no transmitting” or “no receiving,” the user no longer has any freedom of choice. Starting from an unrestricted (possibly non-existent) functional specification of the issuer, such as “transmit to all” and/or “receive from all,” the user can select a user specification completely freely. Starting from a partially restricting functional specification of the issuer, such as “transmitting only to ID group 1 or to ID group 2,” the user can select a narrower user specification, such as “transmitting only to IDI from ID group1 or to ID2 from ID group1.”

The coin deposit managing unit 30 comprises a coin deposit creation unit 32, which can process a coin deposit request 402 of the issuer, and a user specification unit 33, which can process a configuration request 403 of the user. A user can transmit the configuration request 403 to the coin deposit managing unit 30 from his user unit 40, such as a mobile data device, PC, or terminal.

The user specification unit 33 checks in particular whether the specifications for his coin deposit 330 contained in the configuration request 403 and selected by the user are narrower than the existing issuer specifications 334 of the coin deposit 330. In this case, the specifications in the configuration request 403 are stored in the coin deposit 330 as user specifications 333. In the coin deposit managing unit 30, the user specification 333 can always be narrower than the issuer specification and the restrictions of the issuer specification 334. It is then sufficient that the secure execution unit 31 check the user specification. When indicating the permissible recipients and/or senders in the specification, this variant is preferred. On the other hand, the secure execution unit—preferably for other specifications or encodings—can also be configured to always check both specifications 333, 334. The user specification 334 then does not have to comprise the possibly existing restrictions of the issuer specification 333. The management of the user specification(s) 333 can thus be simplified.

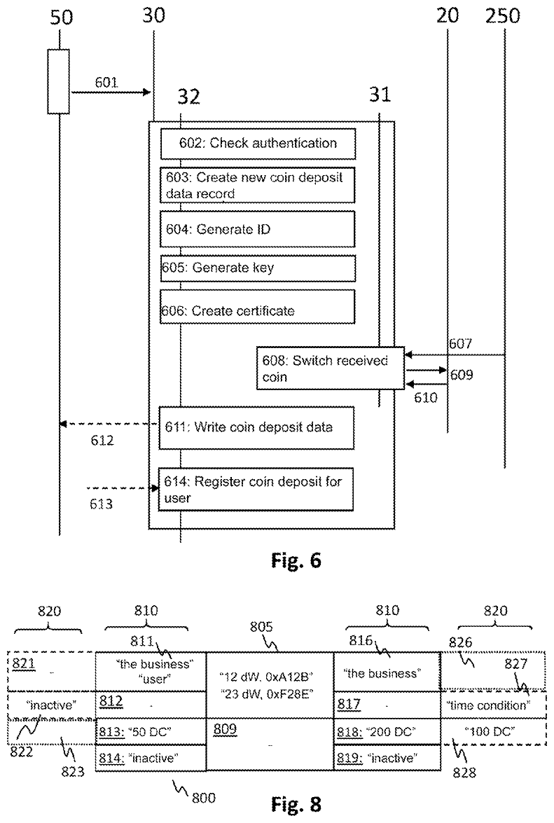

The coin deposit 330 can be or have been created as a new coin deposit at the request 402 of the issuer entity 50. The coin deposit request 402 contains, as a data element, at least one, and generally several, functional issuer specifications 334 for the new coin deposit 330. A corresponding method is described in more detail below with reference to FIG. 6.

The execution unit 31 is configured to exchange the coin data sets of the coin deposits in transactions 405, 406 with coin managing units and to transmit registration requests to the coin register.

A key management module 38 of the coin deposit managing unit 30 is preferably a high-security module for cryptographic keys. The key management module 38 can store secret keys of the coin deposits 310, 320, 330. The key 338 of the coin managing unit 330, 31 stored in the coin deposit 330 is, for example, a public key of an asymmetrical key pair. The associated secret key is stored in the key management module 38 (and used only in this module). The key management module 38 encrypts, authenticates, or signs, for example, data for the secure execution unit 31 with the secret key of the coin deposit. Individual key pairs can be provided for the different purposes. The key management module 38 may additionally create derived keys, such as session keys, and provide them to the execution unit.

In addition to managing the transaction keys (keys required for the transactions), the key management module 38 can also be used for the encrypted storage of the coin data sets.

The data sets of the coin deposits 310, 320, 330 are preferably stored in encrypted form in the coin deposit managing unit 30. If required, i.e., for example, in a transaction request or configuration request for the coin deposit 330, the coin deposit is decrypted. Only the coin deposit 330 is decrypted, wherein in particular a key that is individual for the coin deposit can be used. The key management module 38 can, for example, execute the decryption (and a later re-encryption). If the key management module 38 contains a derivation key (optionally, jointly for several coin deposits), it can alternatively provide the derived key for the decryption/encryption of the coin deposit of the secure execution unit 31.

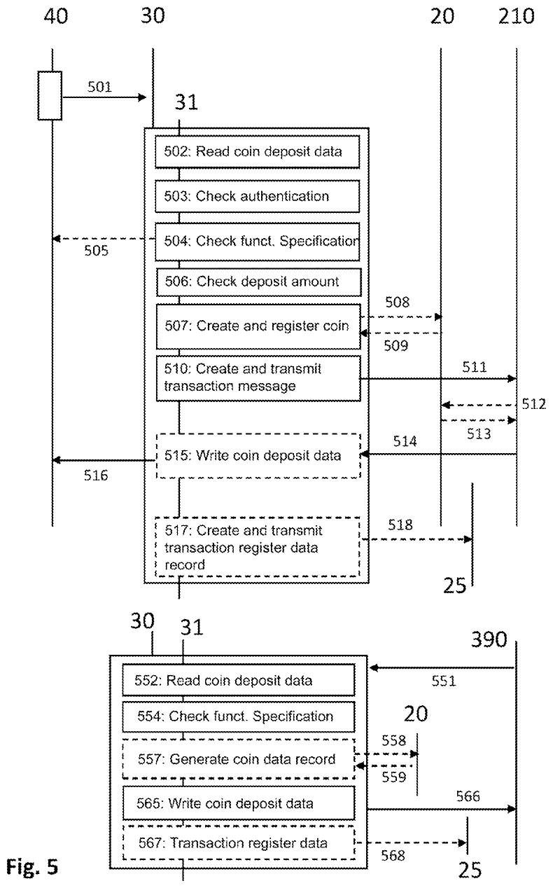

The user can transmit a transaction request 401 from his user unit 40 to the coin deposit managing unit 30. A corresponding method for processing the transaction request 401 is described for the case of transmitting a coin data set, transmission transaction 405, with reference to FIG. 5. The transaction request 401 is a transaction request of the user, which is recognizable as a request of the user in particular by means of an authentication data element or a preceding authentication of the user unit 40. The execution unit 31 checks the functional specification 332 before the transmission transaction is executed (or not), depending upon the check result. The check of the functional specification 332 is also described with reference to FIG. 5 for the case of receiving coin data sets (receipt transaction 406).

The functional specifications 332 can be not only direction specifications, but also, for example, specifications for conditional transactions 416 or specifications for transactions with counter-performance 419. In FIG. 3, it is already indicated that these specifications 416, 419 can also additionally exist.

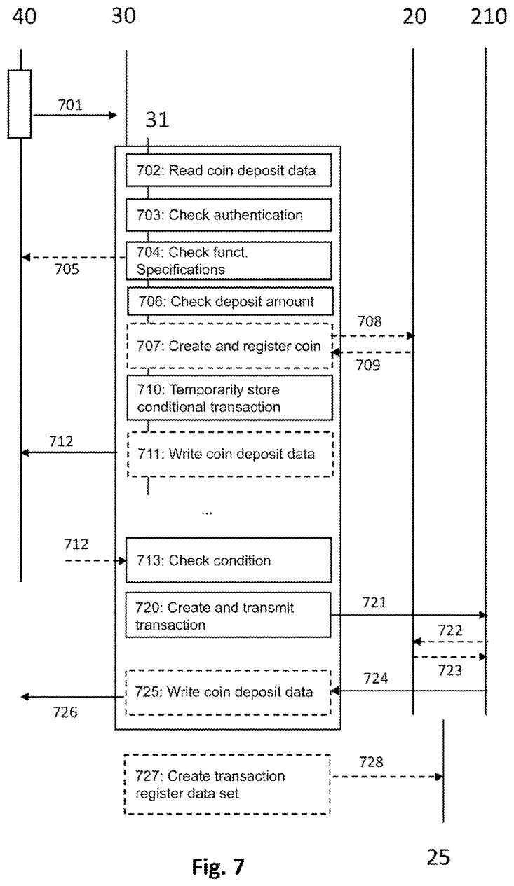

A storage region 436, 26 for the temporary storage of conditional transactions can be provided in the coin deposit 330 or across coin deposits. Conditional transactions are first temporarily stored, and later executed after the condition has been met. A corresponding method is described in more detail with reference to FIG. 7.

In order to be able to execute a transaction with counter-performance, the coin deposit managing unit 30 comprises a counter-performance unit 39. The counter-performance unit 39 generates, for example, response data, which are to be transmitted in a response as a counter-performance for one (or more) coin data sets received in a receipt transaction 406. The counter-performance unit provides a counter-performance that can be set in counter-performance data 439 of the coin deposit 330. The counter-performance specifications restrict the counter-performance functions permissible for the coin deposit 330. Starting from the counter-performance functions available in the counter-performance unit 39, specific counter-performance functions, encodings, or subtypes are thus selectively excluded for the coin deposit.

FIG. 5 shows the method sequence 501 through 518 in the coin deposit managing unit 30, after the receipt of a transaction request 501 from a user 40 (or the user's user unit), as well as the method sequence 551 through 568 when receiving coin data sets from a coin managing unit 390.

The transaction request 501 comprises an ID of a coin deposit in the coin deposit managing unit 30 and requests the transmission of an amount from this sender ID to a recipient ID. The secure execution unit 31 of the coin deposit managing unit 30 reads the coin deposit data of the coin deposit. Preferably, the key management module 38 of the secure execution unit 31 either provided the decryption key, which is selected individually for the coin deposit, or provided the already decrypted coin deposit data. In steps 503, 504, 506, the secure execution unit 31 executes several checks before it executes the requested transaction in steps 507 through 516. FIG. 5 shows the preferred sequence of the checking steps. First, an authentication is checked 503—generally, the authentication of the user. A corresponding authentication value can be contained in the transaction request 501 or can be requested and received separately in step 503.

At least one (of the) functional specification(s) of the coin deposit is checked in step 504. In the present example of a simple transmission transaction, it is checked whether the recipient ID is an ID according to the functional specification. If the coin deposit according to the issuer specification is unrestricted in the receipt direction or the issuer specification is met in the receipt direction, the user specification, which comprises an ID group and two ID's of recipients, will be checked. If the recipient ID of the transaction request does not correspond to the functional specification, the transaction request 501 will be rejected, with the user 40 receiving a rejection message 505. If, in contrast, the recipient ID is permissible because it is an ID from the ID group or corresponds to one of the two ID's of recipients in the user specification, the method will be continued (and the transaction executed). In step 506, it is checked whether the deposit amount, the amount of the coin data set in the coin deposit, or sum of the amounts of the coin data sets in the coin deposit, is greater than the requested amount.

The coin deposit managing unit 30 preferably transmits precisely one coin data set in transactions, the amount of which corresponds to the transaction amount, instead of transmitting the transaction amount as the sum of amounts of several coin data sets. If the requested amount corresponds to the amount of an existing coin data set in the coin deposit, the next steps 507 through 509 will be omitted. In step 507, a new coin data set is created, the amount of which corresponds to the requested amount. Preferably, an existing coin data set is divided into the new coin data set and an additional coin data set (amount=difference between the amount of the existing coin data set and the transaction amount). Alternatively, two or more existing coin data sets could be connected to the new coin data set (and optionally one or more additional coin data sets). A registration request 508 is transmitted to the coin register 20 for the new coin data set (or its register reference). The coin register 20 confirms 509 the registration.

In step 510, the secure execution unit 31 now creates a transaction message 511, which is transmitted to the coin managing unit 210 with the recipient ID. The transaction message 511 comprises a transaction ID, the ID of the coin deposit, the recipient ID, and the new coin data set. Optionally, the transaction message 511 contains a transaction reference text, which generally originates from the transaction request, and/or an authentication value, which is generated for the transaction with the aid of the secret key of the coin deposit. Preferably, a mutual authentication of the two coin managing units (310, 31, and 210) involved is carried out in the transaction, and in particular in step 511. The step 510 of creating and transmitting the transaction message 511 can optionally or alternatively run in several sub-steps with a plurality of exchanged sub-messages (only, for example, for the authentication).

The coin managing unit 210 optionally generates its own coin data set, which in particular is equal to the amount of new coin data set received, transmits a registration request 512 for its own coin data set to the coin register 20, and then receives a registration confirmation 513 from the coin register 20. The coin managing unit 210 transmits a transaction confirmation 514 to the coin deposit managing unit 30.

In step 515, i.e., preferably only after receipt of the transaction confirmation 514, the secure execution unit 31 stores the changed coin deposit data of the coin deposit. As described above, a coin deposit-specific encryption of the coin deposit data can take place—in turn, optionally, with the aid of the key management module 38.

A transaction confirmation 516 can be transmitted to the user 40. In preferred variants, a transaction register data set 518 is created in step 517 and transmitted to the transaction register 25.

A JSON format is preferably used for the transaction request 501 and/or the transaction message 511. A first, uniform format, and in particular the JSON format, is preferably used for messages within the transaction layer 3. However, it should be noted that the contents of the transaction request 501 and/or the transaction message 511 can also be transferred separately from one another. For example, an authentication value can first be transmitted in step 503, or a recipient ID can first be transferred in step 504, and/or an authentication of the coin managing unit 210 (or a mutual authentication) can initially be executed before a coin data set is exchanged.

The second sequence shown in FIG. 5 is triggered by reception of a transaction message 551 or receipt transaction from a coin managing unit 390. The transaction message 551 contains at least one ID of a coin deposit in the coin deposit managing unit 30. The coin managing unit 390 thus wants to transmit a coin data set to the coin deposit. However, the secure execution unit in turn checks whether the transaction corresponds to the functional specifications of the coin deposit.

First, the coin deposit data of the coin deposit with the indicated ID are read 552. The reading 552 of the coin deposit data will comprise, as before, a decryption. Optionally, an authentication of the coin managing unit 390 is checked, or a mutual authentication is executed. Now, the secure execution unit 31 checks 554 the functional specification of the coin deposit. If receiving is completely restricted for the coin deposit, for example, the transaction message 551 will be rejected. In the example, however, receiving is partially restricted for the coin deposit by a sender specification of the issuer. The secure execution unit 31 thus checks whether the ID of the coin managing unit 390 meets the sender specification of the issuer for the coin deposit. In the negative case, the transaction is rejected; in the positive case, the transaction is executed. The secure execution unit preferably generates its own coin data set using the received coin data set. It can generate 557 its coin data set in the same amount and register it with the coin register by registration request 558 and registration confirmation 559. The coin deposit data of the coin deposit are stored 565 (encrypted) and a transaction confirmation 566 is transmitted to the coin managing unit 390. Optionally, a recipient of coin data sets may also be obligated in the digital central bank currency system to generate 567 a transaction register data set and to transmit 568 it to the transaction register 25.

FIG. 6 shows the sequence of a method for creating a new coin deposit. An issuer 50 of the new coin deposit transmits a coin deposit request 601 to the coin deposit managing unit 30. The coin deposit creation unit 32 of the coin deposit managing unit 30 processes the coin deposit request 601 and creates the new coin deposit. First, the authentication of the issuer is checked 602. If the check of the authentication fails, e.g., because the requester is not an issuer but a user, the request will be rejected (or no new coin deposit created). The coin deposit managing unit 30 comprises a plurality of coin deposits assigned to different users. The coin deposits comprise different specifications, and in particular different functional specifications. The plurality of coin deposits has been created by a plurality of issuers. The plurality M of the coin deposits is on the order of magnitude of a plurality B of the users (M=a*B—for example, where 1<a<9 for 1 to 9 coin deposits per user). The plurality of coin deposits M is orders of magnitude greater than the plurality H of the issuers: M>>H (for example: M=b*H, where b>50, and preferably >100).

In step 603, a coin deposit data set for the new coin deposit is created. The data elements of the generated coin deposit data set are initially empty and/or occupied by a default value. In the step of creating 603 the coin deposit data set, the individual encryption key can be provided for the coin deposit—in particular, by the key management module 38. The data elements, such as specifications and coin data sets, or in particular also identifier, key, and/or certificate, are now provided in additional steps 604-608 or incorporated from the coin deposit request 601.

First, an identifier for the new coin deposit is generated 604 in the coin deposit managing unit 30. The new coin deposit forms a new coin managing unit together with the secure execution unit 31. Identifiers are assigned in the system to coin managing units. The identifier is designed, in particular, as a URI, Unified Resource Identifier, or URN, Unified Resource Name, and contains a universally unique ID (UUID). An identifier as a URN has, for example, the following format: “coinmanagingunit: my-coin-deposit-bank.com: UUID.” A UUID can be used as an identifier or as a part of a URN. The UUID is encoded according to RFC 4122. It accordingly comprises a half-byte M, which indicates a version of the UUID, and a half-byte N, which indicates a variant of the UUID. Additional bits of the UUID are now used to at least partially encode a functional specification. For example, bits of the half-bytes S and/or V can be used here: “xxxxxxxx-XXXX-Mxxx-Nxxx-SVxxxxxxxxxx,” which would otherwise be occupied by random numbers. In a first bit of the UUID, it is encoded that the coin deposit is present in a coin deposit managing unit. In a second bit of the UUID, it is encoded whether a direction-related functional specification is present (“0”: no direction specification, “1”: “direction specification”). In a third bit of the UUID, it is encoded whether conditional transactions are permissible (“0”: “no conditional transactions” or “1: conditional transactions permissible”). In a fourth bit of the UUID, it could optionally be encoded whether a counter-performance is permissible (“0”: no counter-performance permissible, “1” counter-performance permissible). For conventional coin managing units, the 3 bits of the UUID could thus be set to “000.”

For the new coin deposit, according to coin deposit request 601, transmission should be restricted to two different recipient groups, and a named variant of conditional transactions should be permissible which can comprise a counter-performance. The three bits of the UUID are therefore set to “111” for the new coin deposit. As expected, only one (or more) direction specification exists for the plurality of coin deposits in the coin deposit managing unit 30, but conditional transactions or counter-performances are not permitted. For most coin deposits, the three bits would thus be encoded with “100” in their URN or UUID.

In an additional step, at least one key for the coin deposit is provided or generated. A key pair comprising a public key and a secret key is generated-preferably by the key management module. The secret key can optionally remain in the key management module. Alternatively, it is stored in encrypted form in the (optionally additionally encrypted) coin deposit. The public key is stored in the coin deposit. The key or the key pair preferably serves to authenticate the new coin managing unit.

In an additional step 606, a certificate is created for the coin deposit. The certificate comprises at least the ID and/or the public key of the coin deposit. Certificates confirm the authenticity of the contained data elements for third parties. The certificate, like the ID or the public key, is a (public) data element of the coin deposit data set provided for forwarding to third parties, such as other coin managing units. The functional specifications for counter-performance are therefore not contained in the certificate. The exact restriction in the transmission and receipt directions, i.e., here, the two permissible recipient groups, are also treated as internal information. However, an (additional) part of the functional specifications is contained in the certificate. The certificate contains, for example, the indication that the coin deposit is unrestricted in the receipt direction (“no sender specification”) and is partially restricted in the transmission direction.

Optionally, the secure execution unit 31 receives 607 one or more coin data sets for the new coin deposit. As already described above, the secure execution unit will generate its own (or several of its own) coin data set(s) for the received coin data set(s). It transmits a registration request to the coin register 609 and receives a confirmation 610 for the registration of its own coin data set(s) in the coin register 20. Generally, own coin data sets in the same amount are generated and registered (switching). It is not shown in the figures that, in turn, a transaction register data set is preferably transferred to the transaction register 25.

In step 611, the coin deposit data set—in particular, including the mentioned data elements, the externally provided data elements, and optionally at least one coin data set-is stored. It is preferably stored in individually encrypted form. The encryption can pertain to the entire coin deposit data set or to individual data elements (D1, D2, D3) (e.g.: “encrypt (D1,D2,D3 . . . )” or “encrypt (D1), encrypt (D2), encrypt (D3). . . ”).

After the new coin deposit has been created, the coin deposit creation unit 32 can transmit a coin deposit confirmation 612 to the issuer 50.

A step 614 of registering the new coin deposit for a user can take place at different times. The assignment between a unique username-optionally including “first name, last name, date of birth, and/or address” or “tax number with or without first name, last name” of the user—and the coin deposit, i.e., the ID of the coin deposit, is generally stored in an external data structure. If the user is already named in the coin deposit request 601, the assignment or the registration 614 can take place as soon as the ID of the coin deposit is fixed (in the example: as of step 604).

The registration 614 in FIG. 6 is triggered with a separate assignment request 613, which pertains to at least one coin deposit already created, but not yet associated with a user. The issuer 50 could thus have a plurality of new coin deposits created (steps 601 through 612) and assign them to a user only as required (at a later time, and possibly individually) (steps 613, 614). It is conceivable for several coin deposits to simultaneously request the assignment. The issuer can transmit the assignment request 613. Generally, the user is then informed that a new coin deposit has been created for him (for example, including indication of the ID or access data). Alternatively, the user or a third party can transmit the assignment request 613. The issuer shares an authorization code with the user (e.g., in an email and/or as a barcode). The user or a third party who first verifies the identity of the user (e.g., by means of postal identification or video identification methods) then transmits the authorization code with or in the assignment request 613.

The coin deposit preferably does not yet comprise any coin data sets at the time of registration 614. Thus, for example starting from the transaction register 25, all transactions can be assigned to users in the system.

It can now be seen that the aspects or features described for individual figures can also be used individually or together in other figures. The new coin deposit according to FIG. 6 can, for example, be a coin deposit according to one of FIGS. 2 through 8. In order to avoid repetitions, not all details relating to each figure are repeated again or not all the alternatives are mentioned for each of the details. The key management, communication with the coin register and the transaction register, and in particular the differently combinable specifications are only a few corresponding examples.

FIG. 7 shows the sequence of a method when a conditional transaction is requested. The request for a conditional transaction 701 from the user 40 first triggers almost the same steps 702, 703, 706, 707, 708 as a normal transaction to be executed immediately with steps 502, 503, 506, 507, 508 in FIG. 5. Since, as in FIG. 5, a transmission transaction is also considered a conditional transaction in FIG. 7, the later steps 720 through 728 correspond respectively to the known steps 510 through 518. Such steps, which have already been described, will be discussed only briefly.

The coin deposit data 702 of the coin deposit indicated with its ID in the transaction request 701 is read, and the user authentication 703 of the user 40 is checked, for example, as described in FIG. 5.

Analogously, the request 701 will also be rejected 705 if it is determined when checking 704 the functional specification(s) of the coin deposit that the transaction is not permissible for the coin deposit.

In the step of checking 704, (at least also) a specification for conditional transactions is now checked as a functional specification. In addition to the functional specification, a direction specification and/or an amount specification, for example, can optionally be checked—in the present example of a transmission transaction, the specification for the transmission direction and a possibly existing amount limit for the transmission.

The additional steps of checking the deposit amount 706 and of creating 707 and registering a coin data set 708, 709 for the transaction could in turn take place analogously to FIG. 5.

A conditional transaction is first temporarily stored 710. It has therefore not yet been executed, but, rather, is executed only later when the condition contained in the transaction is met. As is shown in FIG. 4, the temporary storage can be in a buffer store for conditional transactions 436 of the coin deposit 330, or in an overarching coin deposit buffer store 36 for conditional transactions. It should be noted that the sequence shown-first checking 703 through 705, then temporarily storing 710-ensures that the conditional transaction can actually be executed as soon as the condition is met.

In an optional step 711, the secure execution unit 31 stores the coin deposit data set—in particular, if the coin deposit data have changed. Storing 711 or temporarily storing 710 may in turn comprise encrypting the coin deposit data, as previously described. The coin deposit data will have changed, for example, if the buffer store 436 of the coin deposit is used. Likewise, with the optional steps 707 through 709, a coin data set can already have been generated for the conditional transaction. The coin data set for the conditional transaction can be stored in the coin data sets of the coin deposit. It is preferably marked there as a coin data set reserved or blocked for the conditional transaction. In an alternative, the coin data set for the conditional transaction could be temporarily stored in the conditional transaction itself—in particular, when the buffer store 436 of the coin deposit is used. In an additional alternative, the coin data set for the conditional transaction is created only after temporary storage 710. There are various possibilities for ensuring that the temporarily stored transaction can be executed. The transaction amount can be subtracted from the available deposit amount (for steps of checking the deposit amount such as steps 706 or 506). If the available deposit amount is provided as a separate data element of the coin deposit, it will be reduced. An amount reserved for conditional transactions could also be provided as a data element of the coin deposit data set. An additional possibility for saving storage space would be to take into account not only the available coin data sets in steps of checking 506, 706 the deposit amount, but also to read the temporarily stored conditional transactions of the coin deposit.

The three dots after step 711 in FIG. 7 indicate that the additional steps 712 through 728 follow only at a later point in time. The processing of the transaction request 701 for a conditional transaction is concluded.

The conditional transaction is executed only if and/or only when the condition has been met. FIG. 7 shows a step of checking the condition 713, which is executed, for example, at regular time intervals or is executed in response to the reception of a check trigger 712.

The conditional transaction can, for example, comprise a temporal condition. The transmission transaction is not executed until a specific date or until a certain point in time (for example, after 36 hours or after 11:00 PM or on a specific day of the week).

The conditional transaction can comprise a security value. The transaction is not executed until or is only executed when the security value of the secure execution unit has been provided. The security value can be a random number or a cryptographic security value which is derived in particular from the data of the conditional transaction (such as a hash value or a signature, about a portion of the conditional transaction or the conditional transaction, respectively). The security value can in particular be received as the or in the check trigger 712.

The conditional transaction can comprise an external triggering event. The occurrence of the external triggering event is preferably received in or with the check trigger 712 (from a third party or the transaction partner). The content of the data received with the check trigger 712 is then checked. Alternatively, the secure execution unit can check, e.g., by requesting from an external server or an external data structure (such as blockchain or database), whether the triggering event has occurred.

The conditional transaction can furthermore comprise a temporal limit (execution before a point in time or date). The condition, such as the security value or the external event, must thus be met before the temporal limit is reached. Once the temporal limit is reached, the conditional transaction will no longer be executed. A temporarily stored conditional transaction is deleted after its temporal limit has passed.

A conditional transaction is optionally executed exactly once or several times. The number of executions of the conditional transaction can be indicated in the conditional transaction.

A specification for conditional transactions can indicate, for example, a permissible type or the permissible types of condition, such as temporal condition, security value, and/or external event. Alternatively or additionally, a specification for conditional transactions can contain a type of the conditional transaction which is permissible for the coin deposit. For example, the specification can indicate whether a conditional transmission transaction is permissible, possibly unrestricted, or partially restricted in accordance with a general transmission specification or in accordance with a separate transmission specification for conditional transactions. Analogously, the specification can indicate whether a conditional receipt transaction, a conditional transaction with counter-performance, or a conditional transaction according to a specific scheme (default 1 or proprietary 2) is permissible. Such specifications for conditional transactions can in particular be defined by the issuer in advance for the coin deposit and/or selected by the user. As already stated, they functionally restrict the coin deposit to certain functions from the available functions that the secure execution unit provides.

The additional steps of creating 720 the transaction (message), exchanging at least one coin data set 721 through 724, writing 725 the coin deposit data, confirming the transaction 726, and registering the transaction in the transaction register 727, 728 have already been described in relation to FIG. 5.

Just as a coin deposit can comprise several direction specifications and amount specifications, the coin deposit can also comprise, alternatively or additionally, a plurality of specifications for conditional transactions (such as specifications from issuer and/or user for the different types and/or directions).

In the example of FIG. 8, different specifications of a coin deposit data set are described, as can be present in principle and with different content in each of the coin deposits discussed.

Several specifications 811-828 are shown as data elements of a coin deposit data set 800, and two coin data sets are shown in the coin data sets 805 in a symbolically simplified manner (amount 13 or 23 with “DC” as digital currency units of the central bank currency).

The coin deposit comprises, on the one hand, issuer specifications 810 and user specifications 820. On the other hand, it comprises both receipt specifications 811-814; 821-823 and transmission specifications 816-819; 826-828. Based upon the representation in FIG. 3, in FIG. 8, the receipt specifications are arranged on the left of the coin data sets 805 and the transmission specifications are arranged on the right thereof.

Finally, for functional specifications, a distinction is made between direction specifications 821, 811, 816, 826, specifications for conditional transactions 822, 812, 817, 827, and specifications for transactions with counter-performance 814, 819. The coin deposit also comprises amount specifications 813, 838, 828.

The issuer has defined the issuer specifications 810 at the point in time of the creation of the coin deposit. The user specifications 820 are selected by the user, but selected to be narrower than the similar issuer specifications 810.

The issuer is the owner of a business. He restricts the coin deposit created by him for the user, and therefore, in the transmission specification 816, to his business, “the business.” In practice, the transmission specification 816 therefore contains the ID(s) of the coin management unit(s) of the business, and not a plain text name, as shown in the figure. The user can thus transmit coin data sets of the coin deposit created by the issuer only to the permanently indicated business. The user is not allowed to additionally restrict this specification; for this reason, he is not prompted to select a transmission specification of the user 826. This is indicated in the figure by a box with a dotted-line border. In the receipt direction, the issuer has provided in its receipt specification 811 that coin data sets may be received from the business or from the user. The user can (optionally, and therefore shown by dashed lines) select a stricter receipt specification of the user 821. In the example, the user has not selected a receipt specification, but could have selected, for example, a restriction to “the business” or to “none.”

As can be seen in the issuer specifications for conditional transactions 812, 817, the issuer has not restricted the coin deposit of the user separately with regard to conditional transactions. However, its transmission and receipt specifications 811, 816 are also valid for conditional transactions. The user has decided not to allow conditional receipt transactions, as can be seen in the user specification 822 for the receipt direction of conditional transactions (“inactive”). Furthermore, the user does not want to allow just any conditional transmission transactions, but only to allow the type of condition useful for him-the temporal condition that he wants to use for the business. He has selected “temporal condition” in his user specification 827.

For the coin deposit, the issuer has also permanently specified amount specifications 813, 818. According to the issuer specification 813, the coin deposit may receive a maximum of 50 digital currency units in a transaction and, according to the issuer specification 818, transmit a maximum of 200 digital currency units in a transaction.

An additional restriction of the amount is not offered to the user in the receipt direction (dotted box) for user specification 823. In the transmission direction, the user has selected 50 digital currency units as the maximum transmission amount for his coin deposit in the specification 828.

Finally, the issuer has excluded the available option of executing transactions with counter-performance with the coin deposit. The issuer specifications for transactions with counter-performance 814, 819 are a complete restriction (“inactive”).

The user can now, for example, first transmit 50 DC from another coin managing unit to the coin deposit. A deposit amount of 85 DC is then present in total in the coin deposit. He could now transmit the entire deposit amount in a single transaction to the indicated business (in a new coin data set with 85 DC or with the three existing coin data sets). However, he can also create a conditional transmission transaction that uses a temporal condition, provided that the recipient is the business. The user could, for example, request a conditional transmission transaction which transmits 20 DC to the coin managing unit of the business every two weeks. As described with respect to FIG. 7, the requested transaction is checked, stored temporarily, and then executed every two weeks. The business then provides the user with a counter-performance, indicated in advance or in a transaction reference text, every two weeks (depending upon the business: vegetable box, fresh coffee, or lawn-mowing). However, the counter-performance can also be transmitted in digital form—in particular, in an email, SMS, or a response to the transaction message (in the example: access code to fitness studio valid for 2 weeks).

The encoding of the specifications 811-828 is shown as text for better readability in the figure, but can be encoded in any length and encoding (one or more bits, one or more bytes, byte sequences . . . or numerical, hexadecimal, binary, string . . . coding). An encoding of the data elements of the coin deposit as a TLV structure (tag, length, value) is also conceivable as an encoding of the coin deposit in a JSON format. The issuer data 809 can contain, for example, an expiration point for the coin deposit (validity limit). Further already mentioned data elements of a coin deposit, such as, only by way of example. the additional data elements 337-339 or 436 from FIG. 3, are not shown, but can of course exist.

In the context of the invention, all of the elements described and/or shown and/or claimed can be combined with one another as desired.

1-24. (canceled)

25. A coin deposit managing unit, comprising:
a secure execution unit for managing digital coin data sets of a central bank,
wherein the secure execution unit is adapted to exchange digital coin data sets with coin managing units and to send registration requests to a coin register of the central bank, and
a first coin deposit that comprises at least a first digital coin data set, and a second coin deposit that comprises at least a second digital coin data set;
wherein the coin deposit managing unit manages coin deposits of different users; and
the first coin deposit comprises a first functional specification which checks the secure execution unit in the managing of coin data sets, and the second coin deposit comprises a second, different functional specification which checks the secure execution unit in the managing of coin data sets.

26. The coin deposit managing unit according to claim 25, wherein functional specifications relate to a function executable by the secure execution unit, in particular, completely or partially restricting, or not restricting, the executable function for the coin deposit.

27. The coin deposit managing unit according to claim 25, wherein the first and/or the second functional specification is a transmit or receive specification which restricts the sending of coin data sets or the receiving of coin data sets for the coin deposit.

28. The coin deposit managing unit according to claim 25, wherein
a transmit specification of the first and/or the second coin deposit is different from its receive specification; and/or
at least one partially restricting transmit specification restricts the sending of coin data sets to exactly one recipient, exactly one recipient group, or to several recipients and/or recipient groups; and/or
at least one partially restricting receive specification restricts the receiving of coin data sets to exactly one sender, exactly one sender group, or several senders and/or sender groups; and/or
the first functional specification as a send or receive specification of the first coin deposit comprises the second coin deposit,
wherein in particular the second coin deposit is a recipient or sender, and the only authorized recipient or sender, for coin data sets of the first coin deposit.

29. The coin deposit management unit according to claim 25, wherein the first and/or the second functional specification is a specification for conditional transactions.

30. The coin deposit managing unit according to claim 29, wherein
a conditional transaction for a coin deposit is buffer stored, in particular in a buffer store of the coin deposit or in a buffer store, extending over more than one coin deposit, of the coin deposit managing unit; and/or
the secure execution unit executes the conditional transaction only when a condition is met that is contained in the conditional transaction, and/or
a conditional transaction comprises a temporal condition; and/or
a conditional transaction comprises an external triggering event and/or a securing value; and/or
a specification for conditional transactions contains a type of condition and/or a type of the conditional transaction which is permissible for the coin deposit.

31. The coin deposit managing unit according to claim 25, wherein
the first and the second coin deposit each comprise several functional specifications, and/or
the first and second functional specification relate to the same function executable by the secure execution unit.

32. The coin deposit managing unit according to claim 25, wherein the first and/or the second coin deposit further comprises an amount specification, i.e., a non-functional specification:
a maximum value for the amount of the coin data sets to be sent and/or for the amount of the coin data sets to be received, or
a maximum value or a minimum value for the total amount of the stored coin data sets.

33. The coin deposit managing unit according to claim 25, wherein the first and second functional specification comprise:
a defined functional minimum specification, which is initially defined in particular by an issuer of the coin deposit, and/or
a selectable functional specification, which is to be selected in particular by the user so that it is narrower than a defined functional specification.

34. The coin deposit management unit according to claim 25, wherein, the first and the second coin deposit are assigned to a first user; or
wherein the first coin deposit is assigned to a first user, and the second coin deposit is assigned to a second user.

35. The coin deposit managing unit according to claim 25, wherein the first and/or the second coin deposit further comprises one or more of the following data elements:
a unique coin managing unit identifier, which in particular identifies the coin deposit and the secure execution unit,
a public coin managing unit key of an asymmetrical key pair; optionally, a secret coin managing unit key of the asymmetrical key pair; and/or
a coin managing unit certificate, which in particular comprises the coin deposit identifier and/or the public coin deposit key as certified contents.

36. The coin managing unit according to claim 25, wherein the first and/or the second coin deposit comprises at least one partially freely-readable specification, and in particular the first or second functional specification;
wherein in particular a readable portion and a non-readable portion of the at least partially freely-readable specification are present; and
wherein the two portions are stored in different data elements, or
stored in a common data element in a non-readable manner, and additionally the readable portion is stored in a separate readable data element.

37. The coin managing unit according to claim 25, wherein the first and/or the second functional specification is a counter-performance specification,
wherein the counter-performance is provided as performance in response to at least one received coin data set, and in particular in the response data to the sender of the received coin data set.

38. The coin managing unit according to claim 25, wherein the secure execution unit for managing the coin data sets
transmits transaction register data to a transaction register,
wherein the transaction register data comprise in particular a unique transaction identifier, a transaction amount, a coin managing unit identifier of the sender, a coin managing unit identifier of the recipient, and the register reference of the coin data set in the coin register, and/or
transmits registration requests to the coin register, which comprises at least one register reference of a coin data set previously registered in the coin register and a register reference of a coin data set to be registered in the coin register.

39. A method for managing coin deposits in a coin deposit management unit that comprises a secure execution unit for managing digital coin data sets of a central bank, a unit for creating new coin deposits, and several coin deposits of different users, comprising the steps of:
receiving a request for creating a new coin deposit;
creating the new coin deposit, wherein the creation comprises a step of storing coin deposit data;
wherein the request comprises a functional specification, and
the stored coin deposit data comprise the functional specification.

40. The method according to claim 39, wherein the unit for creating new coin deposits executes at least one of the following steps:
checking an authentication contained in the request;
generating a coin managing unit identifier, which in particular comprises a portion of a specification, and of the functional specification;
generating a coin managing unit key;
providing a coin managing unit certificate, which comprises a portion of a specification or an additional portion of the specification, and of the functional specification.

41. The method according to claim 39, wherein the stored coin deposit data comprises at least one coin data set,
wherein the secure execution unit for managing digital coin data sets
receives a coin data set for the new coin deposit, and/or
transmits a registration request to a coin register of the central bank which, in particular for a received, previously registered coin data set, requests the registration of a coin data set to be stored in the new coin deposit.

42. The method according to claim 39, wherein
the request comprises a user for which the new coin deposit is created; or
the new coin deposit is created without a user assignment, and an assignment of the created new coin deposit to a user takes place in response to an assignment request.

43. A method for managing digital coin data sets in a coin deposit managing unit comprising a secure execution unit and several coin deposits of different users with at least one digital coin data set of a central bank, comprising the steps of:
receiving a transaction request which relates to one of the coin deposits;
reading the coin deposit data of the coin deposit;
checking whether a specification is met;
executing a transaction or storing a conditional transaction corresponding to the transaction request when the specification is met;
wherein in the step of checking, a functional specification contained in the coin deposit data is checked.

44. The method according to claim 43, wherein
the functional specification is a direction specification; and/or
the functional specification is a specification for conditional transactions; and/or
the functional specification is a counter-performance specification.

45. The method according to claim 43, wherein
the transaction request is received by the user, and the conditional transaction is stored as a conditional transaction released by the user; and/or
the conditional transaction is only temporarily stored during storage and is executed when a triggering condition is met, or when stored as a release frame of the user for later transaction requests of a third party, which is named in particular as the recipient in the conditional transaction; and/or
the transaction request or an additional transaction request from a third party is a triggering condition for a conditional transaction, wherein in particular either the temporarily stored conditional transaction is executed, or a transaction requested by the third party is executed, which transaction falls under a stored conditional transaction released by the user.

46. The method according to claim 43, wherein the execution of the transaction, and in particular the requested or the conditional transaction, comprises:
transmitting or receiving a coin data set of the central bank, and/or sending a registration request to a coin register of the central bank, which, in particular for a received previously registered coin data set, requests the registration of a coin data set to be stored in the new coin deposit, and/or
transmitting transaction register data to a transaction register, and/or providing a counter-performance, wherein in particular the transaction request comprises a coin data set.

47. The method according to claim 39, wherein a coin deposit managing unit, comprising:
a secure execution unit for managing digital coin data sets of a central bank,
wherein the secure execution unit is adapted to exchange digital coin data sets with coin managing units and to send registration requests to a coin register of the central bank, and
a first coin deposit that comprises at least a first digital coin data set, and a second coin deposit that comprises at least a second digital coin data set;
wherein the coin deposit managing unit manages coin deposits of different users; and
the first coin deposit comprises a first functional specification which checks the secure execution unit in the managing of coin data sets, and the second coin deposit comprises a second, different functional specification which checks the secure execution unit in the managing of coin data sets; and/or,
according to a method comprising the steps of a method for managing digital coin data sets in a coin deposit managing unit comprising a secure execution unit and several coin deposits of different users with at least one digital coin data set of a central bank, comprising the steps of:
receiving a transaction request which relates to one of the coin deposits;
reading the coin deposit data of the coin deposit;
checking whether a specification is met;
executing a transaction or storing a conditional transaction corresponding to the transaction request when the specification is met;
wherein in the step of checking, a functional specification contained in the coin deposit data is checked.

48. A digital central bank currency system, comprising a coin deposit managing unit, comprising:
a secure execution unit for managing digital coin data sets of a central bank,
wherein the secure execution unit is adapted to exchange digital coin data sets with coin managing units and to send registration requests to a coin register of the central bank, and
a first coin deposit that comprises at least a first digital coin data set, and a second coin deposit that comprises at least a second digital coin data set;
wherein the coin deposit managing unit manages coin deposits of different users; and
the first coin deposit comprises a first functional specification which checks the secure execution unit in the managing of coin data sets, and the second coin deposit comprises a second, different functional specification which checks the secure execution unit in the managing of coin data sets;
or configured to execute a method for managing coin deposits in a coin deposit management unit that comprises a secure execution unit for managing digital coin data sets of a central bank, a unit for creating new coin deposits, and several coin deposits of different users, comprising the steps of:
receiving a request for creating a new coin deposit;
creating the new coin deposit, wherein the creation comprises a step of storing coin deposit data;
wherein the request comprises a functional specification, and
the stored coin deposit data comprise the functional specification;
and the coin register of the central bank, and optionally comprising a plurality of coin managing units and/or further coin deposit managing units and/or a transaction register.
